(19) United States
(12) Patent Application Publication
(10) Pub. No.: US 2010/0306040 A1
(43) Pub. Date: Dec. 2, 2010

(54) ON-LINE REFERRAL

(75) Inventors: Avinash Arumugam, San Francisco, CA (US); Yannick Pierre Bercy, San Jose, CA (US); Mrugan Ujwal Bhorkar, Milpitas, CA (US); Emanuele Fabrizio, San Jose, CA (US)

Correspondence Address: HAYNES AND BOONE, LLP;IP Section, 2323 Victory Avenue, Suite 700, Dallas, TX, 75219, US

(73) Assignee: eBay Inc., San Jose, CA (US)

(21) Appl. No.: 12/475,306

(22) Filed: May 29, 2009

(51) Int. Cl. G06Q 30/00

(52) U.S. Cl. 705/14.16

(57) ABSTRACT

Various methods and systems are provided to facilitate on-line transactions through the issuance of rewards for users who referral a product that is purchased by another. In one example, a user selects a product that the user purchased and an email recipient. The payment provider, who the user used to purchase the product, sends an email with a URL to the recipient, where the URL contains the merchant product page and the email address of the user or person making the referral. If the recipient purchases the referred product, such as clicking on the link or copying and pasting the URL, the payment provider is notified and issues a reward to the user based on the purchase by the recipient.

### BACKGROUND

1. Field of the Invention

The present invention generally relates to on-line transactions and more particularly to referrals to facilitate online transactions.

2. Related Art

More and more consumers are purchasing items and services over electronic networks, such as the Internet. Consumers routinely search for and purchase products and services from merchants and individuals alike. The transactions can take place directly between an on-line merchant or retailer and the consumer, where payment is typically made by entering credit card or other financial information. Transactions can also take place with the aid of an on-line payment provider, such as PayPal, Inc. of San Jose, Calif. Such payment providers can make transactions easier and safer for the parties. Purchasing through the Internet from the convenience of a consumer's home, office, or virtually anywhere (with mobile devices) is one main reason why on-line purchases are growing faster and faster.

With an ever-expanding market of potential consumers, on-line merchants are constantly looking for ways to attract consumers to their websites. Consumers may also want to know where they can purchase a particular item on-line. One way retailers market their website is to place ads (static, dynamic, and pop-up) on virtually any type of website on the Internet, such as search engines like Yahoo, Google, and MSN, marketplace sites like Amazon, and social networking sites like Facebook. Retailers may also send electronic messages, such as emails or text messages, notifying consumers of sales or providing consumers with coupons.

However, it is often difficult for merchants to target specific consumers for their products. These mass mailed promotions also are often ignored by consumers due to the very nature of mass mailings. It may also be difficult to determine the effectiveness of such general advertisements or promotions. Unsolicited spam-type email messages may be ignored or not trusted by consumers.

Thus, there is a need for a more effective way of promoting on-line products and services that benefit both consumers and merchants.

### SUMMARY

In accordance with an embodiment of the invention, an application provided by a payment provider allows a first user to refer a product or service to a second user via an email and link sent by the payment provider. The first user purchases one or more items from a merchant website, with payment being made through the payment provider. Information about the item(s) is available to the payment provider, such that when the first user access the payment provider website, the first user can view information about purchases made through the payment provider. The first user is able to select a purchased item and refer the item to the second user, e.g., a friend. The referral process may include the first user entering the second user's email address and a message. The payment provider sends the email, along with a link to the product on the merchant website. In different embodiments, the second user sees a message from the payment provider and/or the first user, the link, and a product description and/or picture. The link may be provided by the merchant to the payment provider for inclusion in the email. The second user may click on the link, which redirects the second user to the product page on the merchant website, where the user can then simply add the product to a cart for purchase.

In one embodiment, the link or URL sent from the payment provider to the second user also includes the first user's email address or other identifier. When the second user clicks on the link and is taken to the identified product page on the merchant site, the first user's email address is carried along. Then, when the second user purchases the product, the payment provider is notified, either by the merchant or directly from the second user if the second user uses the payment provider for purchase, of the purchase and the identity of the first user (e.g., email address). As a result, the payment provider can provide rewards or incentives to the first user for referring a product purchased by the second user.

In one embodiment, the payment provider notifies the first user when the first user logs into the payment provider account or when the first user pays for a purchase using the payment provider. Rewards can be based the total dollar amount of referred purchases and/or total number of purchases made through referrals made through a specific merchant or through any combination of merchants (partner merchants, related merchants, or unrelated merchants). The reward can be a percentage discount on the order or a fixed dollar amount based on a minimum purchase amount or no minimum purchase required (e.g., if given as a percentage discount). Merchants, the payment provider, or a combination of both can offer and pay the rewards.

In another embodiment of the invention, a payment provider includes a means, such as a server, for receiving product purchase information by a first user on a merchant website, receiving an email address of a second user and product information, sending a link to the second user that includes the first user's email address and the product page of the merchant, receiving an indication that the second user purchased the product based on the link, and informing the first user of a reward or discount for referring the second user to the merchant. The payment provider may also track information of different user purchases and referrals to provide specific rewards.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a block diagram of a networked system configured to manage on-line referrals in accordance with an embodiment of the invention;

FIG. 2 is a flowchart showing a process performed by the system of FIG. 1 according to one embodiment;

FIGS. 3A-3H show sample screens the user and/or recipient sees during a referral reward process according to one embodiment.

FIG. 4 is a flowchart showing a process performed by a payment provider according to one embodiment; and.

FIG. 5 is a block diagram of a computer system suitable for implementing one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

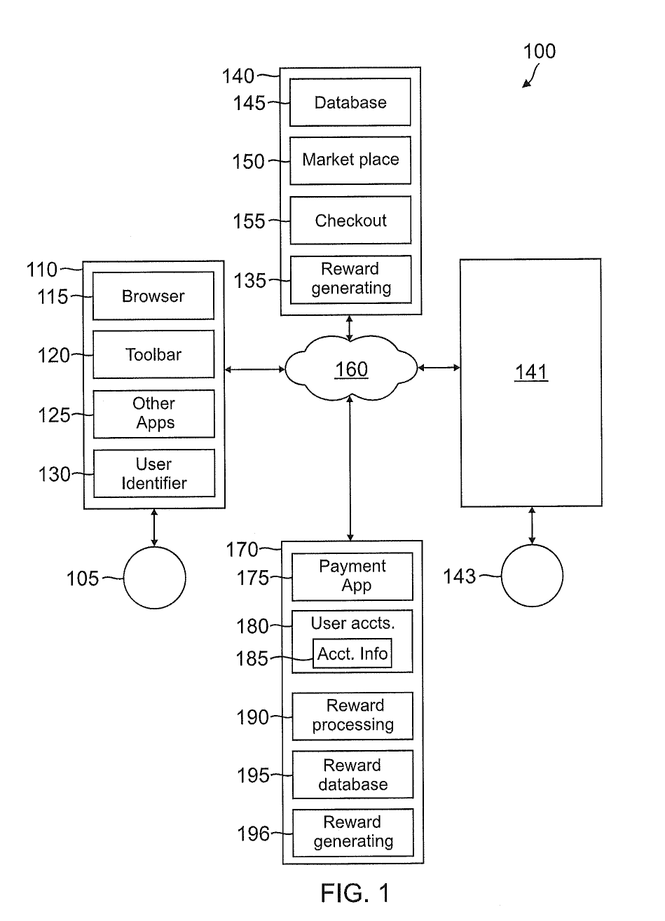

FIG. 1 is a block diagram of a networked system 100 configured to manage online referrals in accordance with an embodiment of the invention. System 100 includes a first client device 110, a merchant server 140, a second client device 141, and a payment service provider server 170 in communication over a network 160. Payment service provider server 170 may be maintained by a payment provider, such as PayPal, Inc. of San Jose, Calif.

Client device 110, merchant server 140, second client device 141, and payment service provider server 170 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

Client devices 110 and 141 may be implemented using any appropriate combination of hardware and/or software configured for wired and/or wireless communication over network 160. For example, in one embodiment, client devices 110 and 141 maybe implemented as a personal computer of a first user 105 and a second user 143, respectively, in communication with the Internet. In other embodiments, client devices 110 and 141 may be implemented as a wireless telephone, personal digital assistant (PDA), notebook computer, and/or other types of computing devices. Client devices 110 and 141 are similar to each other, and thus, descriptions of one client device may apply similarly to the other client device. Consequently, second client device 141 will not be specifically shown or described in detail.

As shown, first client device 110 may include one or more browser applications 115 which may be used, for example, to provide a convenient interface to permit first user 105 to browse information available over network 160. For example, in one embodiment, browser application 115 may be implemented as a web browser configured to view information available over the Internet.

First client device 110 may also include one or more toolbar applications 120 which may be used, for example, to provide client-side processing for performing desired tasks in response to operations selected by first user 105. In one embodiment, toolbar application 120 may display a user interface in connection with browser application 115 as further described herein.

First client device 110 may further include other applications 125 as may be desired in particular embodiments to provide desired features to first client device 110. For example, in various embodiments, such other applications 125 may include security applications for implementing client-side security features, programmatic client applications for interfacing with appropriate application programming interfaces (APIs) over network 160, or other types of applications. Applications 125 may also include email applications that allow first user 105 to send and receive emails through network 160. First client device 110 includes one or more user identifiers 130 which may be implemented, for example, as operating system registry entries, cookies associated with browser application 115, identifiers associated with hardware of first client device 110, or other appropriate identifiers. In one embodiment, user identifier 130 may be used by a payment service provider to associate first user 105 with a particular account maintained by the payment service provider as further described herein.

Merchant server 140 may be maintained, for example, by an on-line merchant offering various products and/or services in exchange for payment to be received over network 160, or hosted by a third party provider (e.g., ISP and shopping carts). In this regard, merchant server 140 includes a database 145 identifying available products and/or services (e.g., collectively referred to as items) which may be made available for viewing and purchase by first user 105 and/or second user 143. Accordingly, merchant server 140 also includes a marketplace application 150 which may be configured to serve information over network 160 to browser 115 of first client device 110 and/or second client device 141. For example, in one embodiment, users 105 and 143 may interact with marketplace application 150 through browser applications over network 160 in order to search and view various products or services identified in database 145.

Merchant server 140 also includes a checkout application 155 which may be configured to facilitate the purchase by users 105 and/or 143 of goods or services identified by marketplace application 150. In this regard, checkout application 155 may be configured to accept payment information from users 105 and/or 143 and/or from payment service provider server 170 over network 160.

In one embodiment, merchant server 140 further includes a rewards generating application 135 which may be configured to generate various rewards such as discounts which may be redeemed by users 105 and/or 143 during interactions with merchant server 140. For example, in one embodiment, rewards generating application 135 may be configured to generate and distribute reward information to payment service provider server 170 for association with various user accounts maintained by payment service provider server 170.

Payment service provider server 170 maybe maintained, for example, by an online payment service provider which may provide payment on behalf of users 105 and/or 143 to the operator of merchant server 140. In this regard, payment service provider server 170 includes one or more payment applications 175 which may be configured to interact with client device 110, client device 141, and/or merchant server 140 over network 160 to facilitate the purchase of goods or services by users 105 or 143 of client device 110 or 141, respectively, from merchant server 140. In one embodiment, payment service provider server 170 may be provided by PayPal, Inc.

Payment service provider server 170 also maintains a plurality of user accounts 180, each of which may include account information 185 associated with individual users. For example, in one embodiment, account information 185 may include private financial information of users of devices such as account numbers, passwords, credit card information, bank information, or other financial information which may be used to facilitate online transactions by users 105 and/or 143. Advantageously, payment application 175 may be configured to interact with merchant server 140 on behalf of users 105 and/or 143 during a transaction with checkout applications 155 or 156 to track and manage purchases made from referrals by users.

In particular, payment service provider server 170 also provides a reward processing application 190 which may be configured to receive reward information from merchant server 140 and/or users for storage in a reward database 195. Reward processing application 190 may be further configured to select reward records from reward database 195 to be provided to users 105 and/or 143.

Payment service provider server 170 further includes a reward generating application 196 which may be configured to generate various rewards such as coupons or discounts which may be redeemed by users 105 and/or 143 during interactions with merchant server 140 when user 105 and/or 143 has referred an item from the merchant to another user and that user purchases the item based on the referral. For example, in one embodiment, reward generating application 196 may be configured to generate and distribute reward information to payment service provider server 170 for association with various user accounts maintained by payment service provider server 170.

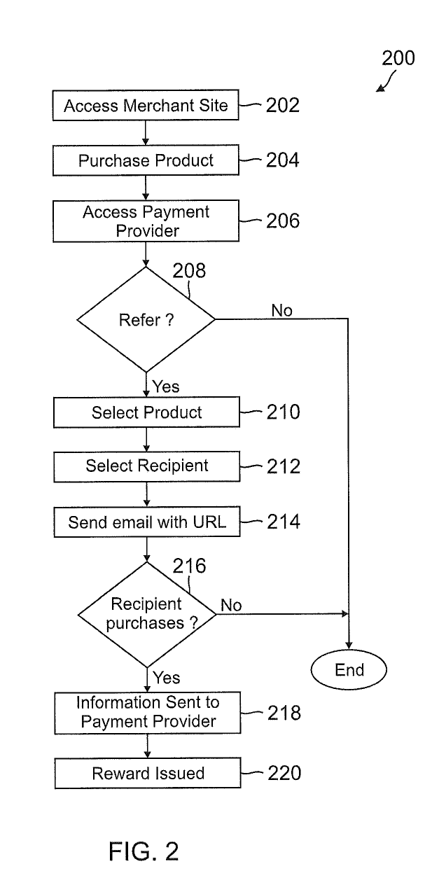

FIG. 2 is a flowchart 200 showing one embodiment of processes that may be performed by system 100. It is assumed that user 105 has previously registered with payment service provider server 170 to open a user account 180. In this regard, it will be appreciated that user 105 may have previously provided account information 185 to payment service provider server 170 over network 160 through, for example, a secure connection between client device 110 and payment service provider server 170.

As a result of such previous registration, client device 110 stores a user identifier 130 that may be used to identify the particular user 105 as having a user account 180 maintained by payment service provider server 170. As previously described, user identifier 130 may be implemented, for example, as one or more cookies, operating system registry entries, hardware identifiers, or other types of identifiers.

Initially, at step 202, a user access a merchant website. This may be through any suitable device, such as client device 110. Once in the merchant website, the user may browse products and/or services for possible purchase. When a user decides to purchase a product or service, the user can simply click on a button to add that product into a shopping cart. Upon checkout, the user then purchases the selected products at step 204. Typically, the merchant site provides the user with various options for purchase or payment. Options may include specific credit cards, debit cards, or payment provider accounts, such as through PayPal, Inc. With payment provider accounts, the user can click on a button or link, which takes the user to the payment provider web site at step 206. Once the payment provider site is accessed, such as by logging in with a user name or email address and a password, communication is also made between the merchant site and the payment provider.

In one embodiment, the merchant site sends information about the product(s) purchased by the user, such as in the form of a URL. The payment provider then associates that product with the user who purchased it. Next, at step 208, the user is given the opportunity to refer the product to one or more recipients. If the user decides to use this feature, the user selects one or more products at step 210. Selection of products can be in any suitable method. In one embodiment, the user is shown a screen with products purchased from one or more merchants. Each product may be associated with a link or button that allows the user to select that product for a referral. In another embodiment, there may be a single button that a user selects for referring product(s). Once selected, the user can then select one or more purchased items for referral.

Next, at step 212, the user selects recipients to refer the selected product(s). In one embodiment, the user types in email address(es) of the selected recipients. In another embodiment, the user selects recipients from a list, such as a contact list. The user may also type in a message for all selected recipients or specific messages for individual recipients. Once the user has selected the product(s) and recipient(s), the user instructs the payment provider to send an email to the designated recipients, such as by clicking on a “send” button or other similar means. Subsequently, at step 214, the payment provider sends an email to the designated recipients about the product referral. The email may include the message from the user, a URL link to the product page on the merchant site, and a picture of the product(s). The email may also include instructions for the recipient to simply click on the link for more details about the product.

In one embodiment, the URL link includes information about the merchant website, the product, and user who referred the product. Thus, by clicking on the link or copying and pasting the URL to a web browser, the user is displayed a page on the merchant's web site showing the product. The recipient can then get more information about the product, such as a detailed description, pictures, and price. At this point, at step 216, the recipient can decide whether to purchase to product. This may be accomplished by clicking on an “Add to Cart” button, “Purchase” button, or other suitable means. The user may then purchase the product or products by any suitable method, and information about the purchase, including the user who referred the purchase, is communicated to the payment provider at step 218.

In one embodiment, the recipient pays via the payment provider. In this case, the information can be communicated directly to the payment provider through the payment process. In another embodiment, the recipient pays with a credit card. Here, once the merchant receives verification from the credit card company that payment has been made, the merchant may communicate the purchase information, including at least the identify of the user who referred the purchase, to the payment provider. Because the payment provider is informed of a purchase that resulted from a user referral, the payment provider is able to process and manage rewards for the user. Thus, with a credit card payment, purchase information may need to be provided by the merchant, as an additional step.

Consequently, at step 220, the payment provider may provide a reward or incentive to the user. This may be accomplished in any number of ways. In one example, when the user logs into the user's payment provider account, there will be a message that the user has received a reward for the referral of a product or products resulting in the purchase of the product or products by the recipient of the referral. In another example, when the payment provider processes the reward, such as when the payment provider has received confirmation that a referred product was purchased, the payment provider sends a notification to the user who made the referral. The notification may be sent as an email to the user, a text message to the user's mobile device, an automated call to the user's mobile device, or other suitable means of communication. In yet another embodiment, the user is notified indirectly through the merchant web site. In this example, the user browses the merchant site (the same site the user used before to purchase and refer), selects one or more products to purchase, and then selects the payment provider as the payment option. Once selected, the user is shown a message informing the user of the reward. Once the user receives the reward notification, the user may use the reward as instructed.

Use may be clicking on a link, clicking on a button, entering a coupon or reward code, downloading the reward to a mobile device for scanning or use at a point of sale, printing out and scanning at a point of sale, or printing out and mailing the reward.

The reward can be in many different forms and can vary depending on numerous factors. For example, the reward may be a coupon for a particular dollar amount off purchase of an item from the merchant, a coupon for a dollar amount off of any purchase made through the payment provider, a coupon for a certain percentage off a purchase from the merchant, a coupon for a certain percentage off any purchase made through the payment provider, coupons for use with specific partner merchants of the payment provider, a “cash” amount that the user can deposit into the user's payment provider account, or a voucher for free merchandise from the merchant.

The value of the rewards may differ depending on various factors. In one embodiment, the value is dependent on the number of purchases made from a user's referrals through all merchants using the payment provider as the payment source, the dollar amount of each item purchased from the merchant based on the referral (in that a reward is issued for each purchase), the total dollar amount spent at a merchant through a user's referrals, the total dollar amount spent by others using the payment provider as the purchasing option on referrals from a user, or a combination thereof.

The reward may be issued directly by the payment provider, directly by the merchant, or by the merchant through the payment provider, in which case the merchant gives the payment provider authority to issue rewards on the merchant's behalf. The rewards may be issued after each successful referral, after a certain dollar value has been reached on the referrals, after a number of successful referrals has been reached, periodically (e.g., weekly), or a combination thereof.

In some embodiments, rewards are not issued based solely on purchases made through a referral. For example, rewards may be issued even with unsuccessful referrals or a combination of successful and unsuccessful referrals, assuming certain conditions are met, such as the number of referrals sent by a user, a minimum number of purchases made by the user that are the basis of the referrals, a minimum dollar amount of purchases made by the user that are the basis of the referrals, and the frequency of the referrals. Thus, even if a user is not that successful with referrals, the user may still be rewarded for the effort. Rewards may also factor in whether referrals resulted in purchases made at the merchant web site or through the payment provider that were not of the product referred. For example, if a user's referral gets the recipient to the merchant site, and the recipient ends up buying something else, user may still be issued some sort of reward.

As a result, the user is incentivized to refer products to others, the payment provider increases chances of others using the payment provider to make purchases, and the merchants receive additional and specialized marketing of both their products and web site. In addition, the payment provider may receive more information from merchants, and consumers may be incentivized to sign up for an account with the payment provider and/or create an account with the merchant.

The ability to provide rewards, as discussed with respect to FIG. 2, is possible with the system shown in FIG. 1, where devices/servers can communicate between each other, store, process, and transmit information, access user accounts for desired information, generate rewards, and conduct purchases between parties.

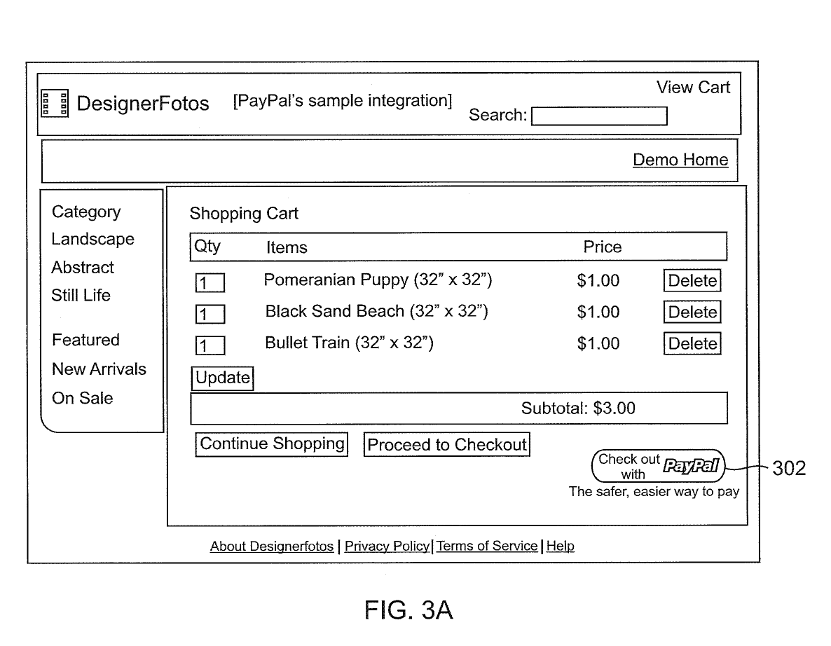

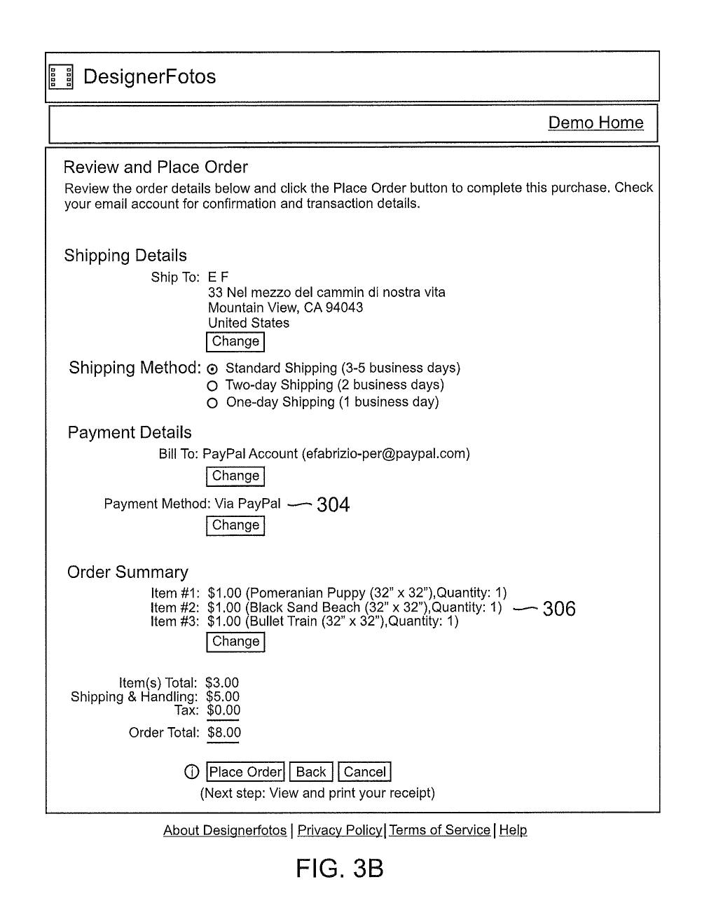

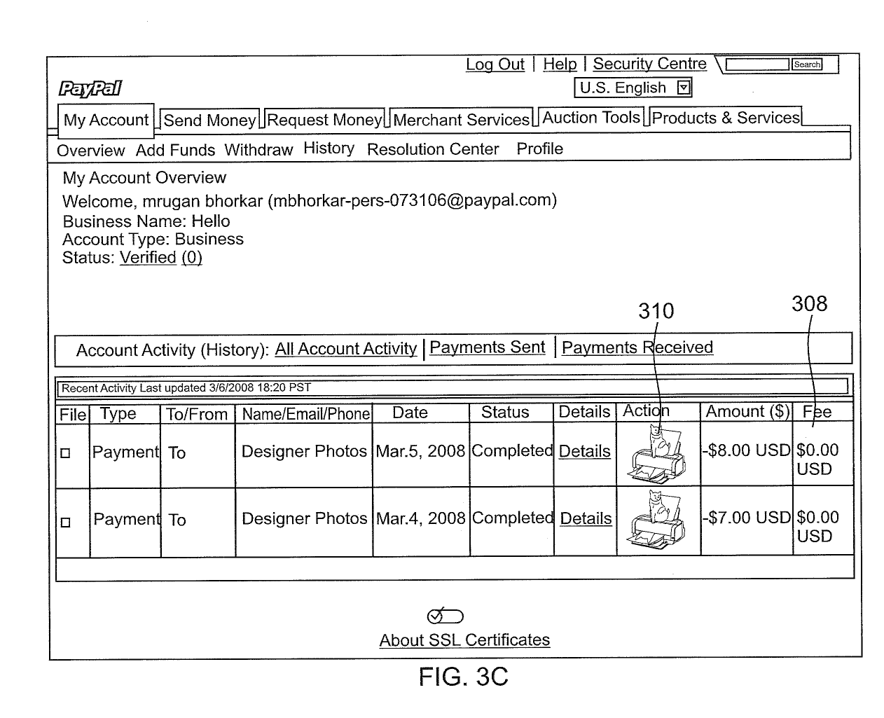

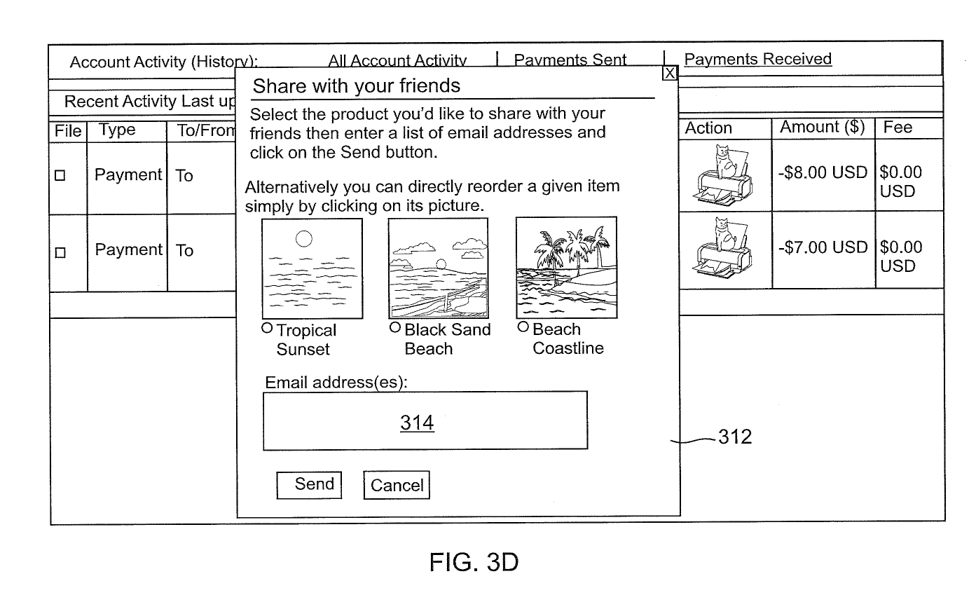

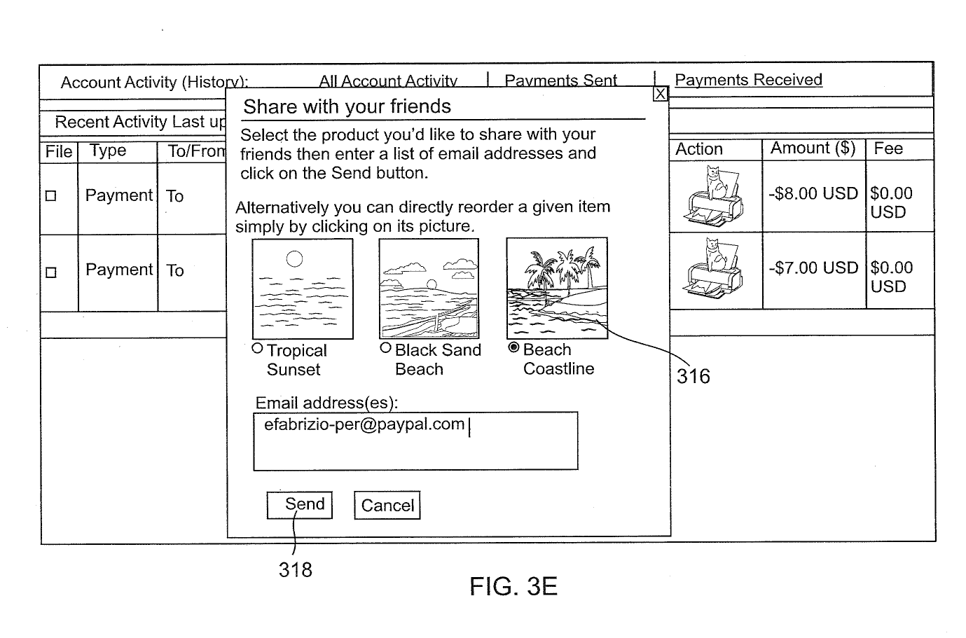

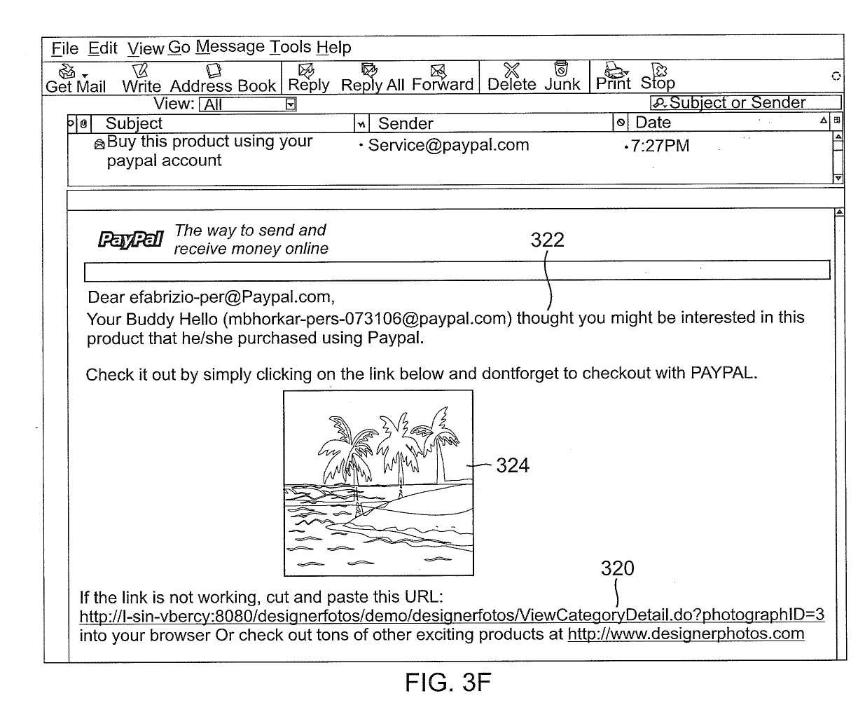

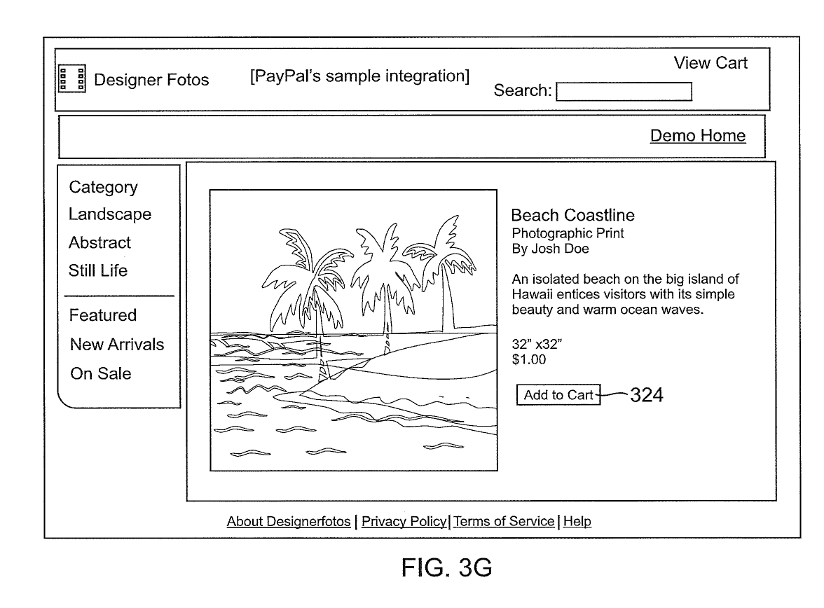

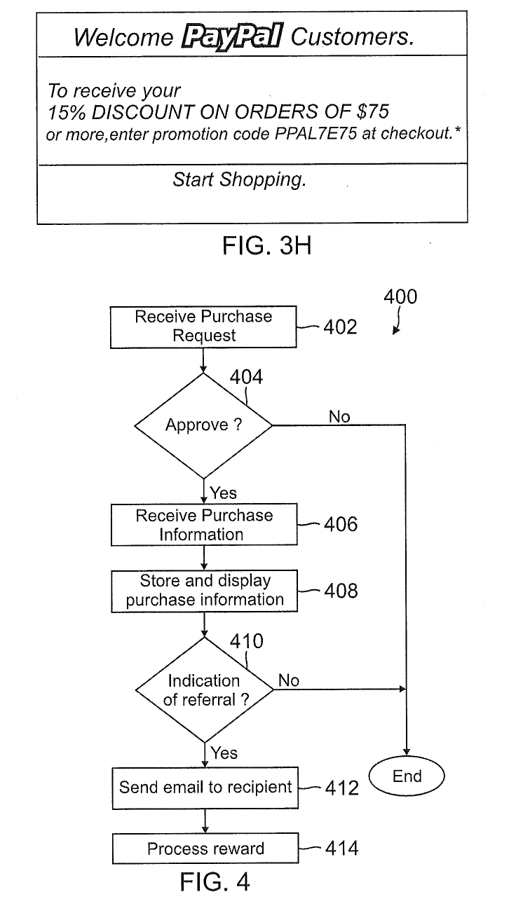

FIGS. 3A-3H show sample screens the user and/or recipient sees during a referral reward process according to one embodiment. FIG. 3A is a screen shot a user sees from a merchant site when the user is ready to purchase the items in the user's cart. As seen, there is an option 302 that allows the user to pay through a payment provider. The payment provider may then require the user to go through a process flow, such as authentication and authorization. FIG. 3B shows a screen shot after the user selects payment option 302 from FIG. 3A, including a portion 304 indicating payment via the payment provider and a portion 306 indicating the items purchased. After the purchase is completed, FIG. 3C is a screen shot the user may see after logging into the user's payment provider account. In the account overview page, the user sees a row indicating the purchase in FIGS. 3A and 3B. Buttons 310 may be displayed that enable the user to click or select to make a referral on the particular purchase or product.

After clicking button 310, a new screen 312 is shown to the user, as seen in FIG. 3D. In this embodiment, screen 312 is overlaid on the previous screen. Because button 310 was associated with a transaction rather than individual items, screen 312 shows all items purchased in the transaction. The user can select the item(s) purchased for referral and is shown a field 314 to type in email addresses for one or more recipients. FIG. 3E shows a screen shot with the user selecting item 316 and entering one recipient's email address. A send button 318, when clicked by the user, prompts the payment provider to send the referral information to the recipient.

The recipient is then shown an email, such as in FIG. 3F. The email includes a URL 320 of the product page on the merchant site, an indication of the user's identify or email 322, and a representation of the item 324. FIG. 3G shows a screen shot if the recipient clicks on the link or copy and pastes the URL. FIG. 3G is the selected item shown on the merchant web site, with an option to purchase 324. FIG. 3H shows a reward notification if the user qualifies for a reward. Note that as discussed above, there may be different ways to qualify, which may not necessarily require the recipient to purchase the actual referred product. Assuming the user qualifies for the reward, FIG. 3H shows one particular reward, which the user sees when the user decides to pay for a purchase (which may or may not be from the same merchant) through the payment provider. The reward shows details of the reward, such as how to redeem and the value/conditions of the reward.

FIG. 4 is a flowchart 400 showing steps performed by a payment provider for issuing a referral reward according to one embodiment. At step 402, the payment provider receives purchase request information, such as when a user is ready to use the payment provider to purchase item(s) from a shopping cart on a merchant retailer's site. The information may include the price, item description, merchant, user information, etc. Once this information is received, the payment provider, at step 404, determines whether to authorize the payment to the merchant. Authorization is conventional and may depend from payment provider to payment provider. If the request is denied, the payment provider notifies the user and/or merchant for any suitable subsequent actions. If the request is approved, the payment provider notifies the user and/or merchant and the transaction is completed.

Once completed, the payment provider receives information about the purchase at step 406, which may include the item description, merchant, and price. The information may be sent by the merchant in a URL or other suitable format. The payment provider stores this information and associates it with the user who make the purchase. In another embodiment, steps 402 and 406 may be combined, such that the shopping cart (information about the purchase) is passed with the payment request. At step 408, the payment provider displays information about purchases made by the user, such as when the user logs into the account or at other times if desired. The display may include a button that the user can click or select for referring a purchase to a recipient. By clicking the button, the payment provider displays the user a page of the selected item(s) for referral or allows the user select specific item(s) for purchase and a field for the user to enter recipient information, such as email addresses and messages. At step 410, the payment provider determines if the user wants to refer one or more purchased products, such as by clicking on a link indicating this or by transmitting information about the referred products and the recipient(s) to the payment provider.

Once the payment provider determines that the user wants to refer purchased product(s), the payment provider uses information provided by the user and stored with the payment provider to send an email to the user's intended recipient(s) at step 412. The email may include a message from the user, a picture of the product, and a link to the product on the merchant web site. The link may also include a way to identify the user referring the product. In one embodiment, the picture of the product may also include another link to a picture hosted on the merchant server, where the picture of the product will not be uploaded on the payment provider servicer, but the merchant will pass the product image and redirect links with the payment information. Next, at step 414, the payment provider processes a reward for the user if the referral qualifies for a reward. Qualification may include different requirements, as discussed above, such as whether the recipient purchased the referred product, whether the recipient purchased something from the merchant site based on the referral, whether a referral number or dollar amount has been reached, etc. The user may then use the reward as set forth in the reward notification.

Note that the user may be notified when the reward is earned, such as through an email, or the user may be notified when the user next logs into the user's payment provider account. Rewards may also be managed by the payment provider. For example, the user may search for rewards based on different parameters, the rewards may be grouped in specific categories, such as type, date, amounts, merchants, or simply listed in an overview page or reward page. Furthermore, the payment provider may automatically apply a reward even if the user does not apply it himself, such as the payment provider matching a purchase with a reward. For example, matching can be if the user is purchasing something from a merchant with a pending award with the user, a particular product is purchased, or a particular dollar amount is used for a purchase.

In other embodiments, the various methods and systems described herein may be modified to accommodate users and/or recipients that are not associated with an existing account with the payment provider. For example, in such embodiments, the merchant or the payment provider may request a user and/or recipient to sign up for the payment provider service and/or create an account with the merchant in order to participate in the referral rewards program, such as when rewards are contingent upon a user making a purchase through a particular merchant and/or using the payment provider service.

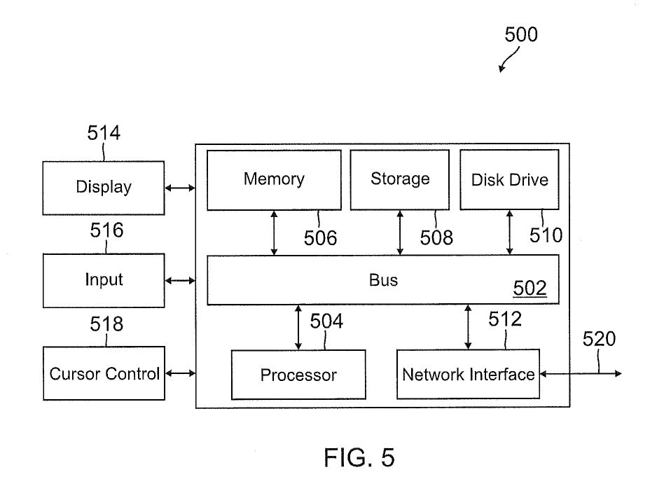

FIG. 5 is a block diagram of a computer system 500 suitable for implementing one or more embodiments of the present disclosure. In various implementations, the user device may comprise a personal computing device (e.g., a personal computer, laptop, cell phone, PDA, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 500 in a manner as follows.

In accordance with various embodiments of the present disclosure, computer system 500, such as a personal computer and/or a network server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 516 (e.g., keyboard, keypad, or virtual keyboard), and a cursor control component 518 (e.g., mouse, pointer, or trackball). In one implementation, disk drive component 510 may comprise a database having one or more disk drive components.

In accordance with embodiments of the present disclosure, computer system 500 performs specific operations by processor 504 executing one or more sequences of instructions contained in system memory component 506, such as described above with respect to the payment provider in FIG. 4. Such instructions may be read into system memory component 506 from another computer readable medium, such as static storage component 508 or disk drive component 510. In other embodiments, hard-wired circuitry may be used in place of or in combination with software instructions to implement the present disclosure,

Logic may be encoded in a computer readable medium, which may refer to any medium that participates in providing instructions to processor 504 for execution. Such a medium may take many forms, including but not limited to, non-volatile media, volatile media, and transmission media. In various implementations, non-volatile media includes optical or magnetic disks, such as disk drive component 510, volatile media includes dynamic memory, such as system memory component 506, and transmission media includes coaxial cables, copper wire, and fiber optics, including wires that comprise bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by a communication link 520 to the network (e.g., such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 520 and a communication interface 512. Received program code may be executed by processor 504 as received and/or stored in disk drive component 510 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, referrals have been described as a user first purchasing a product. However, rewards may also be provided without having the referring party actually purchase the product. The rewards may be the same, different, or lower. Furthermore, exchange of information between the merchant and the payment provider may be at any stage, such that the payment provider has the requisite information before sending the email to the recipient user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method of performing on-line transactions, comprising:
receiving, at a payment provider, information on a product purchased by a user on a seller web site;
enabling the user to make a referral of the product to a known recipient;
transmitting, electronically by the payment provider, information about the product and the user to the recipient; and
processing a reward for the user based on the referral.

2. The method of claim 1, wherein the reward is processed by the payment provider.

3. The method of claim 1, wherein the transmitting is by e-mail.

4. The method of claim 3, wherein the e-mail comprises a link to the product on the seller web site.

5. The method of claim 4, wherein the link comprises information about the user.

6. The method of claim 1, wherein the enabling comprises the payment provider providing a button for the user.

7. The method of claim 1, wherein the processing is by the payment provider.

8. The method of claim 1, wherein the reward is processed even when the recipient does not purchase the product from the referral.

9. The method of claim 1, further comprising notifying the user when the reward after the reward is processed.

10. The method of claim 9, wherein the notifying is a display on a user page of the payment provider.

11. The method of claim 9, wherein the notifying is by e-mail to the user.

12. A machine-readable medium comprising a plurality of machine-readable instructions which when executed by one or more processors of a server are adapted to cause the server to perform a method comprising:
receiving, at a payment provider, information on a product purchased by a user on a seller web site;
enabling the user to make a referral of the product to a known recipient;
transmitting, electronically by the payment provider, information about the product and the user to the recipient; and
processing a reward for the user based on the referral.

13. The machine-readable medium of claim 12, wherein the reward is processed by the payment provider.

14. The machine-readable medium of claim 12, wherein the transmitting is by e-mail.

15. The machine-readable medium of claim 14, wherein the e-mail comprises a link to the product on the seller web site.

16. The machine-readable medium of claim 15, wherein the link comprises information about the user.

17. The machine-readable medium of claim 12, wherein the reward is processed even when the recipient does not purchase the product from the referral.

18. A payment provider system comprising:
means for receiving, at a payment provider, information on a product purchased by a user on a seller web site;
means for enabling the user to make a referral of the product to a known recipient;
means for transmitting, electronically by the payment provider, information about the product and the user to the recipient; and
means for processing a reward for the user based on the referral.

19. The system of claim 18, wherein the transmitting is by e-mail.

20. The system of claim 18, wherein the e-mail comprises a link to the product on the seller web site.

21. The system of claim 20, wherein the link comprises information about the user.

22. The system of claim 18, wherein the reward is processed even when the recipient does not purchase the product from the referral.
